(19) United States
(12) Patent Application Publication
(10) Pub. No.: US 2009/0021525 A1
(43) Pub. Date: Jan. 22, 2009

(54) Display apparatus, display system and method for setting color scheme

(75) Inventors: Liang-Shing Chuang, Taoyuan County (TW); Rong-Wha Wu, Yunlin County (TW)

Correspondence Address: BACON & THOMAS, PLLC, 625 SLATERS LANE, FOURTH FLOOR, ALEXANDRIA, VA, 22314-1176, US

(73) Assignee: Qisda Corporation, Taoyuan (TW)

(21) Appl. No.: 12/219,028

(22) Filed: Jul. 15, 2008

(30) Foreign Application Priority Data
Jul. 18, 2007 (TW) 96126106

(51) Int. Cl. G09G 5/02

(52) U.S. Cl. 345/593

(57) ABSTRACT

A display apparatus, a display system and a method for setting color scheme are provided. The display system comprises a host and a display apparatus. The host comprises a first storage unit and a processing unit. The display apparatus used for displaying a graphical user interface (GUI) comprises a second storage unit and a display control unit. An application program and a color scheme service program are stored in the first storage unit. The processing unit executes the application program for generating a GUI, and executes the color scheme service program for outputting a coordinate parameter according to the GUI. A color scheme selector program is stored in the second storage unit. The display control unit executes the color scheme selector program for setting a color scheme of the GUI according to the coordinate parameter and a color scheme parameter.

This application claims the benefit of Taiwan application Serial No. 96126106, filed Jul. 18, 2007, the subject matter of which is incorporated herein by reference.

### BACKGROUND OF THE INVENTION

1. Field of the Invention

The invention relates in general to a display apparatus, a display system and a method for setting color scheme, and more particularly to a display apparatus, a display system and a method for setting color scheme which adopt different color schemes when different application programs are executed.

2. Description of the Related Art

In 1666, Isaac Newton discovered that when a beam of sun light passed through a prism, a spectrum of light with purple light at one end and red light at the other end was created. The spectrum of colors can be divided into six regions, namely, purple, blue, green, yellow, orange and red.

Cone cells are a receptor of colors for the eyes. Imperial evidences show that the six to seven millions of cone cells in human eyes can be divided into three reception categories corresponding to red, green and blue colors respectively. Of the cone cells, about 65% sense red light, 33% sense green light and only 2% sense blue light. Therefore, when color ratio of the light changes, different colors are sensed by the eyes.

As the display technology advances rapidly, modern people's requirement of image quality also becomes higher and higher. Therefore, how to provide the viewer with better visual effect becomes more and more important.

### SUMMARY OF THE INVENTION

The invention is directed to a display apparatus, a display apparatus, a display system and a method for setting color scheme. When different application programs are executed in an operating system, different color schemes are correspondingly adopted by the display apparatus so as to provide the user with better visual effect.

According to a first aspect of the present invention, a display system comprising a host and a display apparatus is provided. The host comprises a first storage unit and a processing unit. The display apparatus used for displaying a graphical user interface (GUI) comprises a second storage unit and a display control unit. An application program and a color scheme service program are stored in the first storage unit. The processing unit executes the application program for generating a GUI, and executes the color scheme service program for outputting a coordinate parameter according to the GUI. A color scheme selector program is stored in the second storage unit. The display control unit executes the color scheme selector program for setting a color scheme of the GUI according to the coordinate parameter and a color scheme parameter.

According to a second aspect of the present invention, a display apparatus is provided. The display apparatus is used for displaying a graphical user interface (GUI) generated by an application program executed by a host. The display apparatus comprises a second storage unit and a display control unit. A color scheme selector program is stored in the second storage unit. The display control unit executes the color scheme selector program for setting a color scheme of the GUI according to the coordinate parameter and a color scheme parameter of the GUI.

According to a third aspect of the present invention, a method for setting color scheme is provided. The method for setting color scheme is used in a display system comprising a host and a display apparatus. The host and the display apparatus comprise a processing unit and a display control unit, respectively. The method for setting color scheme comprises the following steps:

Firstly, an application program is executed by a host so as to display a graphical user interface (GUI) on a display apparatus. Next, a color scheme service program is executed for outputting a coordinate parameter according to the GUI. Lastly, a color scheme selector program is executed for setting a color scheme of the GUI according to the coordinate parameter and a color scheme parameter.

The invention will become apparent from the following detailed description of the preferred but non-limiting embodiments. The following description is made with reference to the accompanying drawings.

### BRIEF DESCRIPTION OF THE DRAWINGS

FIG. 1 and FIG. 2 shows a block diagram of a display system according to a preferred embodiment of the invention; and

FIG. 3 shows a flowchart of a method for setting color scheme according to the preferred embodiment of the invention.

### DETAILED DESCRIPTION OF THE INVENTION

The embodiments below disclose a display system, a display apparatus and a method for setting color scheme. When different application programs are executed in an operating system, different color schemes are correspondingly adopted by the display apparatus so as to provide the user with better visual effect.

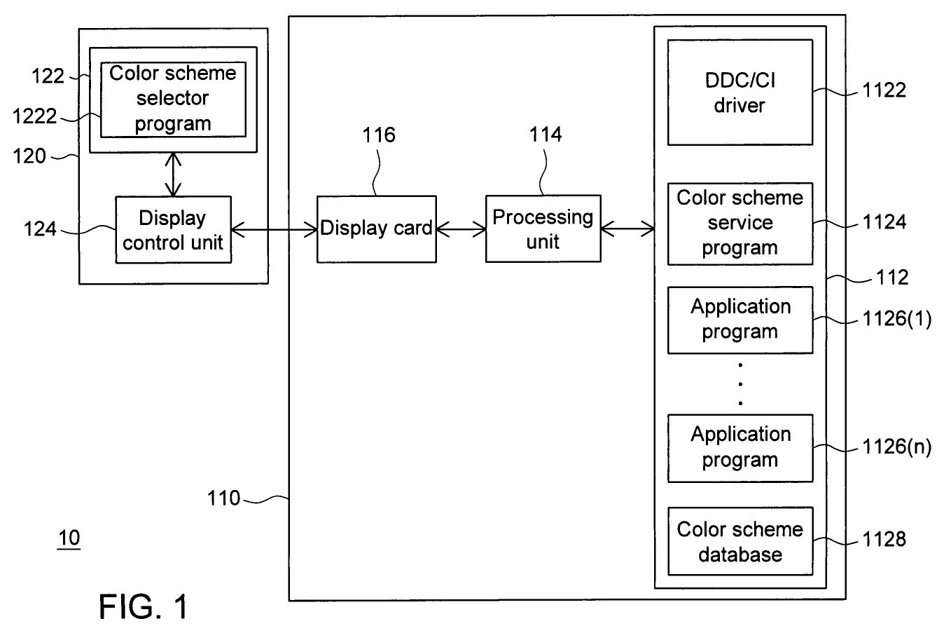

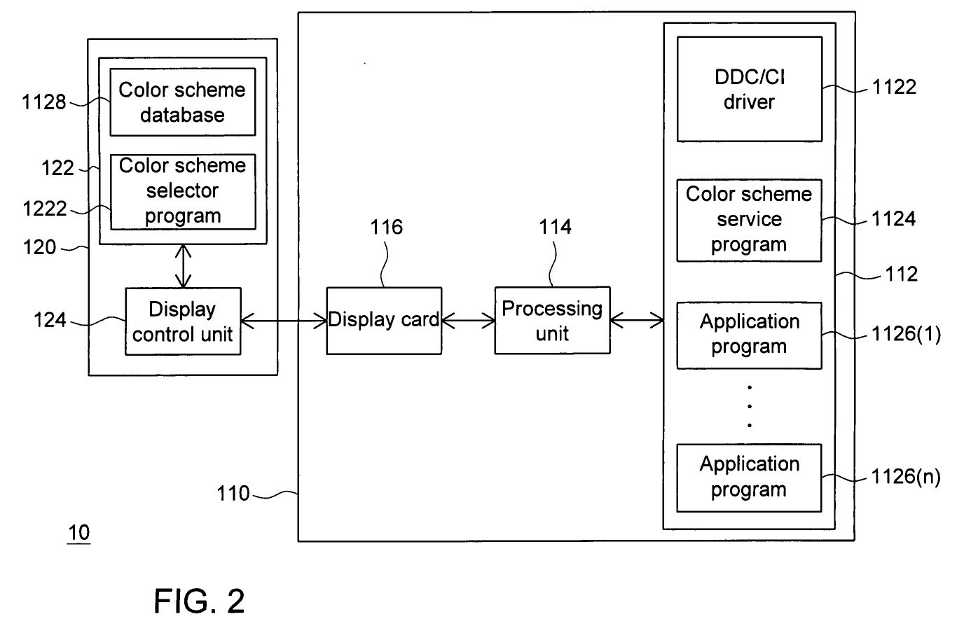

Referring to FIG. 1 and FIG. 2, a block diagram of a display system according to a preferred embodiment of the invention is shown. The display system 10 comprises a host 110 and a display apparatus 120. The host 110 comprises a first storage unit 112, a processing unit 114 and a display card 116. The display apparatus 120 used for displaying a graphical user interface (GUI) comprises a second storage unit 122 and a display control unit 124.

The first storage unit 112 is used for storing a display data channel command interface (DDC/CI) driver 1122, a color scheme service program 1124 and application programs 1126(1) to 1126(n), wherein n is a positive integer not equal to 0. The DDC/CI driver 1122 is used for driving the display card 116 so that data are transmitted between the display card 116 and the display control unit 124 via a DDC/CI.

In an operating system (OS) environment, the processing unit 114 executes at least one of the application programs 1126(1) to 1126(n) for generating a corresponding graphical user interface (GUI). Examples of the application programs 1126(1) to 1126(n) include word processors, movie players and photo browsers. The processing unit 114 executes a color scheme service program 1124 to monitor all application programs currently executed in the OS as well as GUI states and the positions of application programs, and then outputs a coordinate parameter of the GUI accordingly. The coordinate parameter is then transmitted to the display control unit 124 via a DDC/CI.

On the part of the display apparatus 120, the second storage unit 122 is used for storing a color scheme selector program 1222, and the display control unit 124 executes the color scheme selector program 1222 for setting a color scheme of the GUI according to the coordinate parameter and a color scheme parameter.

The color scheme parameter is selected from a color scheme database 1128, which is selectively stored in the first storage unit 112 or the second storage unit 122. The color scheme database 1128 contains various color scheme parameters corresponding to different color schemes for the display control unit 124 to set a color scheme of the GUI accordingly.

The user can define different color schemes for different application programs. Besides, the display system 10 can search the color scheme database 1128 according to the paths, file names and categories of the application programs so as to find out a suitable color scheme parameter.

For example, the application programs 1126(1) and 1126(2) all execute word processing such as Word and Excel, while the application programs 1126(3) and 1126(4) all execute audio/video playing such as Power DVD and Media Player. The application programs 1126(1) and 1126(2) belong to the same category, while the application programs 1126(3) and 1126(4) belong to another category. When the application programs 1126 (1) or 1126(2) are executed, the GUI is set as the same color scheme, and when the application programs 1126(3) or 1126(4) are executed, the GUI is set as another color scheme.

If the color scheme database 1128 is stored in the first storage unit 112, the processing unit 114 outputs a coordinate parameter to the display apparatus 120 according to the position of the GUI in a display frame. The processing unit 114 also selects a corresponding color scheme parameter from the color scheme database 1128 according to which application program is used and then outputs a color scheme parameter to the display apparatus 120 so that the display control unit 124 sets a color scheme of the GUI according to the coordinate parameter and the color scheme parameter.

Or, if the color scheme database 128 is stored in the second storage unit 122, the processing unit 114 outputs a coordinate parameter to the display apparatus 120 according to the position of the GUI in a display frame. The processing unit 114 also outputs a corresponding index to the display apparatus 120 according to which application program is used. The display apparatus 120 selects a corresponding color scheme parameter from a color scheme database 1128 according to an index. Next, the display control unit 124 sets a color scheme of the GUI according to the coordinate parameter and the color scheme parameter. Thus, the transmission time of color scheme parameters is further reduced so as to reduce the time for setting color scheme.

As the color scheme of a GUI varies with the type of an application program, the user gains better visual effect when viewing the display apparatus 120.

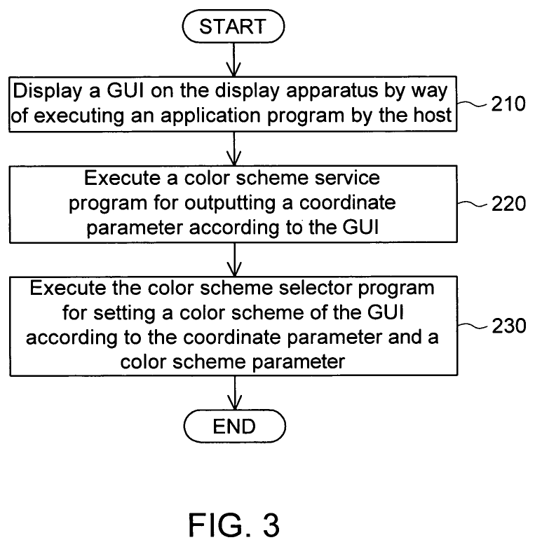

Referring to FIG. 3, a flowchart of a method for setting color scheme according to the preferred embodiment of the invention is shown. The method for setting color scheme comprises following steps: Firstly, as indicated in step 210, the processing unit 114 executes the application program for generating a corresponding GUI in an operating system environment. Next, as indicated in step 220, the processing unit 114 executes a color scheme service program for outputting a coordinate parameter according to the GUI. Lastly, as indicated in step 230, the display control unit 124 executes a color scheme selector program for setting a color scheme of the GUI according to the coordinate parameter and a color scheme parameter.

According to the display system, the display apparatus and the method for setting color scheme disclosed in the above embodiments of the invention, when different application programs are executed in an operating system, different color schemes are correspondingly adopted by the display apparatus so as to provide users with better visual effect.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A display system, comprising:
a host, comprising:
a first storage unit used for storing an application program and a color scheme service program;
a processing unit, which executes the application program for generating a graphical user interface (GUI), and executes the color scheme service program for outputting a coordinate parameter according to the GUI; and
a display apparatus used for displaying the GUI, the display apparatus comprising:
a second storage unit used for storing a color scheme selector program; and
a display control unit, which executes the color scheme selector program for setting a color scheme of the GUI according to the coordinate parameter and a color scheme parameter.

2. The display system according to claim 1, wherein the first storage unit stores a color scheme- database, -the processing unit selects the color scheme parameter from the color scheme database according to the application program, and the host transmits the color scheme parameter to the display apparatus.

3. The display system according to claim 1, wherein the second storage stores a color scheme database, the processing unit generates an index according to the application program, and the display apparatus selects the color scheme parameter from the color scheme database according to the index.

4. The display system according to claim 1, wherein the host further comprises a display card, the first storage unit further stores a display data channel command interface (DDC/CI) driver which drives the display card so that data are transmitted between the display card and the display control unit via a DDC/CI.

5. The display system according to claim 1, wherein the color scheme selector program is a firmware.

6. A display apparatus used for displaying a graphical user interface (GUI) generated by an application program executed by a host executes, wherein the host transmits a coordinate parameter of the GUI to the display apparatus, the display apparatus comprises:
a second storage unit used for storing a color scheme selector program; and
a display control unit, which executes the color scheme selector program for setting a color scheme of the GUI according to a coordinate parameter and a color scheme parameter of the GUI.

7. The display apparatus according to claim 6, wherein the first storage unit stores a color scheme database, wherein the host comprises a processing unit and a first storage unit, the processing unit selects the color scheme parameter from the color scheme database according to the application program, and the host transmits the color scheme parameter to the display apparatus.

8. The display apparatus according to claim 6, wherein the second storage unit stores a color scheme database, the host comprises a processing unit, the processing unit generates an index according to the application program, the display apparatus selects the color scheme parameter from the color scheme database according to the index.

9. The display apparatus according to claim 6, wherein the color scheme selector program is a firmware.

10. A method for setting color scheme used in a display system, wherein the display system comprises a host and a display apparatus, and the method for setting color scheme comprises:
(a) displaying a graphical user interface (GUI) on the display apparatus by way of executing an application program;
(b) executing a color scheme service program for outputting a coordinate parameter according to the GUI; and
(c) executing the color scheme selector program for setting a color scheme of the GUI according to the coordinate parameter and a color scheme parameter.

11. The method for setting color scheme according to claim 10, further comprising:
(d) selecting the color scheme parameter from a color scheme database according to the application program.

12. The method for setting color scheme according to claim 11, further comprising:
storing the color scheme database in a first storage unit of the host.

13. The method for setting color scheme according to claim 11, further comprising:
storing the color scheme database in a second storage unit of the display apparatus.

14. The method for setting color scheme according to claim 10, wherein the host and the display apparatus comprise a display card and a display control unit, respectively, and the method for setting color scheme further comprises:
(e) executing a display data channel command interface (DDC/CI) driver for driving the display card so that data are transmitted between the display card and the display control unit via a DDC/CI.

15. The method for setting color scheme according to claim 10, further comprising:
providing a firmware as the color scheme selector program.

16. The method for setting color scheme according to claim 10, further comprising:
storing the application program and the color scheme service program in a first storage unit of the host.

17. The method for setting color scheme according to claim 10, further comprising:
storing the color scheme selector program in a second storage unit of the display apparatus.

18. The method for setting color scheme according to claim 10, wherein the host further comprises a processing unit and a first storage unit, a color scheme database is stored in the first storage unit, the method further comprising:
selecting the color scheme parameter from the color scheme database according to the application program;
transmitting the color scheme parameter to the display apparatus.

19. The method for setting color scheme according to claim 10, wherein the host further comprises a processing unit, the display apparatus further comprises a second storage unit, a color scheme database is stored in the second storage unit, the method further comprising:
generating an index according to the application program;
selecting the color scheme parameter from the color scheme database according to the index.
